(19) United States
(12) Patent Application Publication
(10) Pub. No.: US 2006/0022524 A1
(43) Pub. Date: Feb. 2, 2006

(54) Distributed power generation, conversion, and storage system

(76) Inventors: Jan Henrik Bryde, Drammen (NO); Mahesh Natverlal Thaker, Moorpark, CA (US)

Correspondence Address: Brian M. Berliner;O'MELVENY & MYERS LLP, 400 South Hope Street, Los Angeles, CA, 90071-2899, US

(21) Appl. No.: 11/107,564

(22) Filed: Apr. 14, 2005

Related U.S. Application Data
(63) Continuation-in-part of application No. 10/361,400, filed on Feb. 10, 2003.

(51) Int. Cl. H02J 9/00

(52) U.S. Cl. 307/64

(57) ABSTRACT

A distributed power generating system enables very rapid and reliable start-up of an engine used to generate back-up power, thereby substantially reducing the need for stored power. More particularly, the distributed power generating system comprises a power bus electrically coupled to commercial power and to a load, an engine comprising a rotatable shaft, a starter/generator operatively coupled to the shaft of the engine and electrically coupled to the power bus, and a temporary storage device electrically coupled to the power bus. The starter/generator is adapted to start the engine from a standstill condition and rapidly bring the engine to an operational speed sustainable by the engine alone. In an embodiment of the invention, the distributed power generating system further comprises switchgear electrically coupled to the power bus, the starter/generator and the load. The switchgear selectively enables delivery of electrical power to the load from the starter/generator without passing through the power bus, delivery of electrical power from the temporary storage device to the starter/generator through the power bus, and/or delivery of electrical power from the power bus to the load. In another embodiment of the invention, the distributed power generating system further comprises second switchgear electrically coupled to the commercial power, the starter/generator and the power bus. The second switchgear selectively enables at least one of delivery of electrical power to the starter/generator from the commercial power without passing through the power bus, delivery of electrical power from the commercial power to the power bus, and delivery of electrical power from the starter/generator to the power bus.

### RELATED APPLICATION DATA

This is a continuation-in-part of co-pending patent application Ser. No. 10/361,400, for DISTRIBUTED POWER GENERATION, CONVERSION, AND STORAGE SYSTEM, filed Feb. 10, 2003.

### BACKGROUND OF THE INVENTION

1. Field of the Invention

The present invention pertains to the generation of electrical power. In particular, this invention relates to distributed power generation systems for use close to where electricity is used (e.g., a home or business) to provide an alternative to or an enhancement of the traditional electric power system.

2. Description of Related Art

Centralized electric power generating plants provide the primary source of electric power supply for most commercial, agricultural and residential customers throughout the world. These centralized power-generating plants typically utilize an electrical generator to produce electrical power. The generator has an armature that is driven by conversion of an energy source to kinetic energy, such as a water wheel in a hydroelectric dam, a diesel engine or a gas turbine. In most cases, steam is used to turn the armature, and the steam is created either by burning fossil fuels (e.g., oil, coal, natural gas, etc.) or through nuclear reaction. The generated electrical power is then delivered over a grid to customers that may be located great distances from the power generating plants. Due to the high cost of building and operating electric power generating plants and their associated power grid, most electrical power is produced by large electric utilities that control distribution for defined geographical areas.

In recent years, however, there has been a trend away from the centralized model of electric power generation toward a distributed power generation model. One reason for this trend is the inadequacy of the existing electric power infrastructure to keep pace with soaring demand for high-quality, reliable power. Electric power distributed in the traditional, centralized manner tends to experience undesirable frequency variations, voltage transients, surges, dips or other disruptions due to changing load conditions, faulty or aging equipment, and other environmental factors. This electric power is inadequate for many customers that require a premium source of power (high quality) due to the sensitivity of their equipment (e.g., computing or telecommunications providers) or that require high reliability without disruption (e.g., hospitals). The utilities that traditionally operate centralized power generating plants are increasingly reluctant to make the large investments in modernized facilities and distribution equipment needed to improve the quality and reliability of their electric power due to regulatory, environmental, and political considerations.

More recently, technological advancements in small-scale power generating equipment has led to greater efficiencies, environmental advantages, and lower costs for distributed power generation. Various technologies are available for distributed power generation, including turbine generators, internal combustion engine/generators, microturbines, photovoltaic/solar panels, wind turbines, and fuel cells. Distributed power generating systems can complement centralized power generation by providing incremental capacity to the utility grid or to an end user. By installing a distributed power generating system at or near the end user, the electric utility can also benefit by avoiding or reducing the cost of transmission and distribution system upgrades. For the end user, the potential lower cost, higher service reliability, high power quality, increased energy efficiency, and energy independence are all reasons for interest in distributed power generating systems.

There are numerous applications for distributed power generating systems. A primary application is to produce premium electric power having reduced frequency variations, voltage transients, surges, dips or other disruptions. Another application is to provide standby power (also known as an uninterruptible power supply or UPS) used in the event of a power outage from the electric grid. Distributed power generating systems can also provide peak shaving, i.e., the use of distributed power during times when electric use and demand charges are high. In such cases, distributed power can be used as baseload or primary power when it is less expensive to produce locally than to purchase from the electric utility. By using the waste heat for existing thermal processes, known as co-generation, the end user can further increase the efficiency of distributed power generation.

Notwithstanding these and other advantages of distributed power generation, there are other disadvantages that must be overcome to achieve wider acceptance of the technology. Conventional distributed power generating systems require further improvements in reliability and efficiency in order to compete effectively with centralized power generation. Distributed power generating systems that utilize an engine to drive a generator tend to be slow to achieve an operational speed from start up, and consequently are slow to provide a source of back-up power. During the time necessary to bring the engine and generator up to operational speed, the distributed power generating system must rely on stored power (i.e., batteries) to supply the back-up source. Battery storage systems are large, expensive, heavy, and have relatively short life expectancy. It is therefore desirable to minimize reliance of the distributed power generating system on batteries.

Accordingly, it would be desirable to provide a distributed power generating system to serve as an alternative to or enhancement of centralized power generation that overcomes these and other drawbacks of conventional distributed power generation. More particularly, it would be desirable to provide a distributed power generating system that achieves an operational state very rapidly so as to reduce the reliance on stored power.

### SUMMARY OF THE INVENTION

The present invention is directed to a distributed power generating system that enables very rapid and reliable start-up of the engine used to generate back-up power, thereby substantially reducing the need for stored power.

The distributed power generating system comprises a power bus electrically coupled to commercial power and to a load, an engine comprising a rotatable shaft, a starter/generator operatively coupled to the shaft of the engine and electrically coupled to the power bus, and a temporary storage device electrically coupled to the power bus. The starter/generator is adapted to start the engine from a standstill condition and rapidly brings the engine to an operational speed sustainable by the engine alone. To accomplish this, the starter/generator has a short time torque capability higher than the rated torque of the engine and starter/generator. When the engine reaches the operational speed, the starter/generator delivers electrical power to the power bus. Upon a fault of the commercial power, the temporary storage device supplies electrical power to the power bus for delivery to the load and for powering the starter/generator until the engine reaches the operational speed, whereupon the starter/generator takes over supply of electrical power to the power bus for delivery to the load. The temporary storage device may further comprise at least one capacitor that is charged by current on the power bus when the engine reaches the operational speed.

In an embodiment of the invention, the distributed power generating system further comprises switchgear electrically coupled to the power bus, the starter/generator and the load. The switchgear selectively enables delivery of electrical power to the load from the starter/generator without passing through the power bus, delivery of electrical power from the temporary storage device to the starter/generator through the power bus, and/or delivery of electrical power from the power bus to the load.

In another embodiment of the invention, the distributed power generating system further comprises second switchgear electrically coupled to the commercial power, the starter/generator and the power bus. The second switchgear selectively enables at least one of delivery of electrical power to the starter/generator from the commercial power without passing through the power bus, delivery of electrical power from the commercial power to the power bus, and delivery of electrical power from the starter/generator to the power bus.

A more complete understanding of the distributed power generating system will be afforded to those skilled in the art, as well as a realization of additional advantages and objects thereof, by a consideration of the following detailed description of the preferred embodiment. Reference will be made to the appended sheets of drawings, which will first be described briefly.

### BRIEF DESCRIPTION OF THE DRAWINGS

FIG. 1 is a block diagram of a conventional distributed power generating system;

FIG. 2 is a block diagram of a distributed power generating system in accordance with an embodiment of the invention;

FIG. 3a is a block diagram showing the flow of power in the distributed power generating system prior to start up;

FIG. 3b is a block diagram showing the flow of power in the distributed power generating system during a first interval following start up;

FIG. 3c is a block diagram showing the flow of power in the distributed power generating system during a second interval following start up; and

FIG. 4 is a block diagram of an alternative embodiment of the distributed power generating system.

### DETAILED DESCRIPTION OF THE PREFERRED EMBODIMENT

The present invention satisfies the need for a distributed power generating system to serve as an alternative to or enhancement of centralized power generation. Specifically, the present invention provides a distributed power generating system that achieves an operational state very rapidly so as to reduce the reliance on stored power. In the detailed description that follows, like element numerals are used to describe like elements illustrated in one or more of the figures.

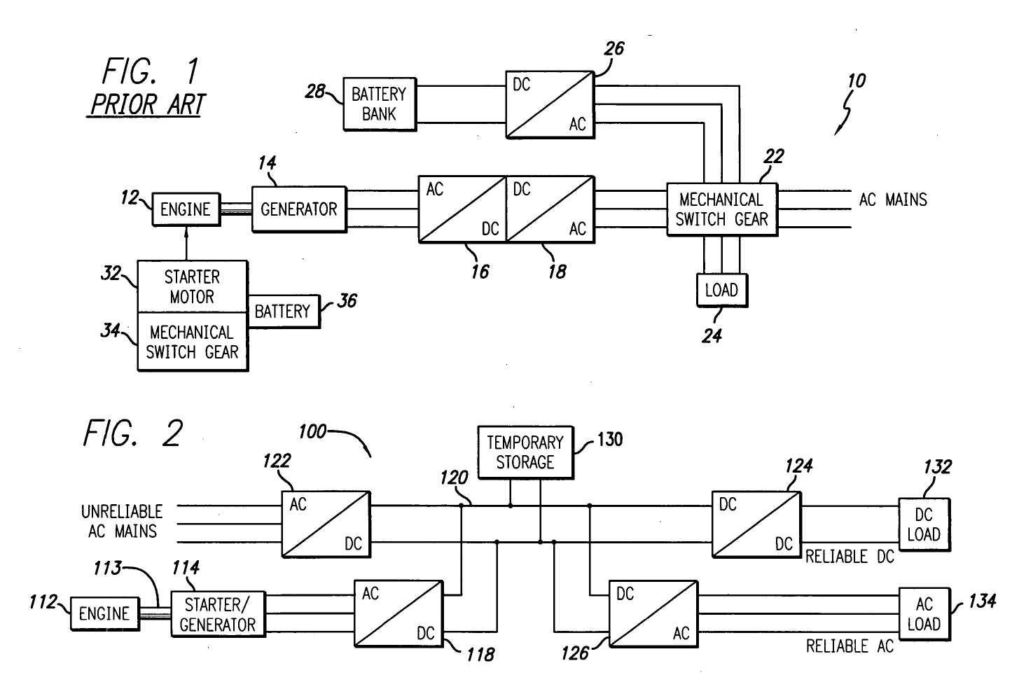

FIG. 1 illustrates a block diagram of a conventional distributed power generating system 10. The distributed power generating system 10 includes switchgear 22 that enables the coupling of AC power to a load 24 from a variety of sources. Under normal conditions, AC power is delivered to the load 24 through the switchgear 22 from the AC power mains connected to the commercial power grid. In the event of a fault of the AC mains, the switchgear 22 cuts off the AC mains and delivers AC power to the load from either a generator 14 or a battery bank 28. The switchgear 22 can also supply the AC output of the generator 14 back to the power grid. The switchgear 22 may comprise a mechanical switch that is manually actuated by an operator or may be adapted to automatically actuate the switch upon detection of a fault.

The power generating system 10 further includes an engine 12 that drives the generator 14. The engine 12 may comprise a reciprocating engine using a combustible fuel such as diesel, gasoline, and the like. The generator 14 converts the rotational energy of a rotor shaft driven by the engine 12 into AC power. The generator 14 is electrically connected to a rectifier 16 that converts the AC power into DC. The rectifier 16 is further electrically coupled to an inverter 18 that converts the DC power back into an AC output, such as a high voltage, three-phase AC output (e.g., 400/480 volts AC), that is delivered to the load 24 through the switchgear 22. Alternatively, the generator 14 may deliver AC power directly to the switchgear 22 without the intervening rectifier 16 and inverter 18,.but it is advantageous to include the rectifier 16 and inverter 18 in order to regulate the frequency, phase and/or amplitude of the AC power delivered to the load 24.

A starter motor 32 connected to the engine 12 by an associated mechanical linkage 34 is used to start the engine 12 from a cold condition. The mechanical linkage 34 enables the starter motor 32 to be disengaged from the engine 12 once the engine has started. A battery 36 provides DC power to the starter motor 32. The battery bank 28 comprises a plurality of batteries (e.g., lead-acid batteries) that are coupled together in parallel to provide a source of DC power. The DC power is converted to AC power by inverter 26, which is in turn delivered to the switchgear 22 for delivery to the load 24. Rectified AC passing through the switchgear 22 from either the generator 14 or the AC mains may be used to charge the battery bank 28.

Upon the detection of a fault with the AC mains, the distributed power generating system 10 goes into the back up mode. The switchgear 22 first connects the battery bank 28 to the load 24 as discussed above to continue to supply AC power to the load. Meanwhile, the engine 12 is started by operation of the starter motor 32. Particularly, the starter motor 32 turns the shaft of the engine 12 at a minimal rate sufficient to begin a reciprocating cycle of the engine 12 (e.g., 500 rpm). When fuel within the cylinders of the engine 12 begins to ignite and the shaft of the engine is able to turn on its own, the starter motor 32 disengages from the engine 12. Eventually, the engine 12 reaches an operational speed (e.g., 3,000 rpm) and the generator 14 begins producing reliable AC power. The switchgear 22 then disconnects the battery bank 28 from the load 24 and connects the generator 14 to the load 24.

As discussed above, there are a number of significant drawbacks with the conventional distributed power generating system 10. First, there are a high number of components, including various mechanical components that are subject to failure. The mechanical switchgear 22 represents a particularly critical component, the failure of which can totally disable the power generating system 10 and further cause the failure of other system components. The mechanical linkage 34 also represents a critical failure point, since the engine 12 cannot be started if there is a failure of the linkage. Second, the engine 12 has a relatively long start-up time due to the use of a small capacity starter motor 32. Since the starter motor 32 is only used to turn over the engine 12 at a minimal rate sufficient to initiate internal combustion, it is known to use a low torque starter motor. If the engine 12 has been sitting idle for a while, it may take several seconds for the engine 12 to start. The battery bank 26 must therefore have sufficient capacity (and hence size) to supply the load 24 during the relatively long start-up time of the engine 12. Batteries have relatively limited life expectancies (e.g., approximately five years) and require routine maintenance to keep them in serviceable condition. Moreover, the battery bank 26 is used only for supplying the load 24 and not for powering the starter motor 32. The separate battery 36 used to power the starter motor 32 is susceptible to discharge, representing yet another critical failure point of the system 10.

The present invention overcomes these and other drawbacks of conventional distributed power generating systems. Particularly, the present invention enables very rapid and reliable start-up of the engine used to generate back-up power, thereby eliminating altogether the need for a battery bank. Moreover, the present invention does not include many of the mechanical components of conventional power generating systems, such as the mechanical switchgear, starter motor and associated linkage, which represent significant failure points of the conventional systems. As a result, the present invention provides a highly reliable and cost effective distributed power generating system.

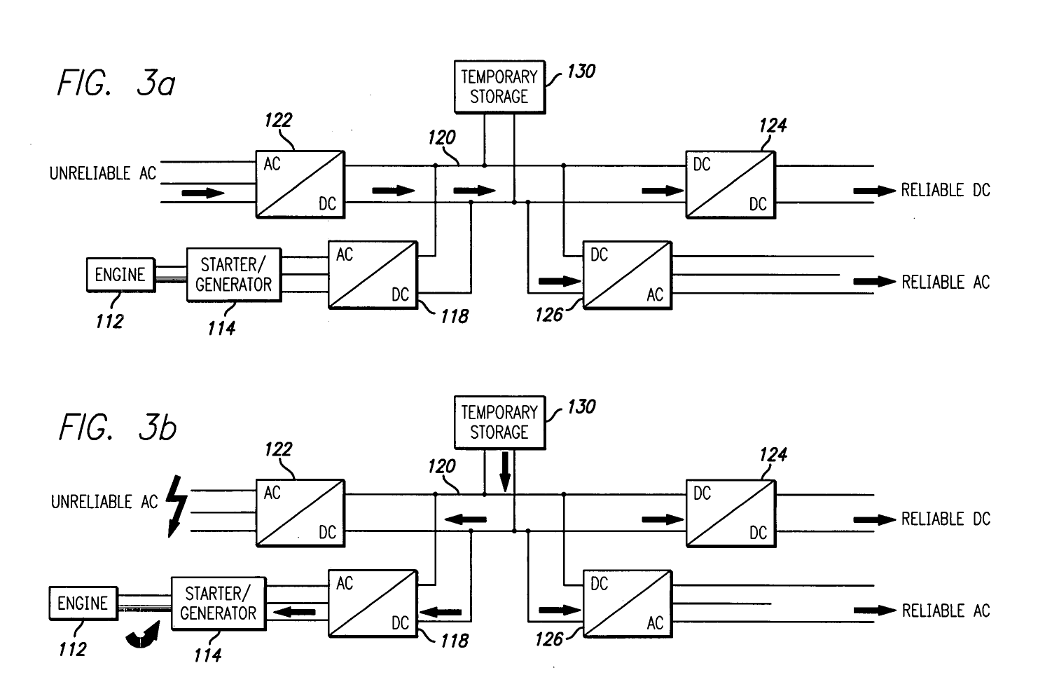

Referring now to FIG. 2, a power generating system 100 is illustrated in accordance with an embodiment of the invention. The power generating system 100 includes an engine 112 and a starter/generator 114. The engine 112 may be provided by a reciprocating internal combustion engine, although other types of engines such as turbines could also be advantageously utilized. The engine 112 is powered using a fuel such as propane, compressed natural gas, diesel or gasoline. The engine 112 drives a rotatable shaft 113 that is operatively coupled to the starter/generator 114. Unlike the conventional systems, the starter/generator 114 provides the dual functions of starting the engine 112 from a standstill condition and producing electrical power after the engine 112 reaches an optimum operational speed, thereby eliminating the need for a separate starter motor, linkage or battery.

Further, the present power generating system 100 avoids the use of mechanical switchgear by including a common DC power bus 120. DC power is supplied to the DC power bus 120 by the AC mains, the starter/generator 114, and a temporary storage 130. Rectifier 122 is electrically connected to the AC mains and delivers rectified DC power onto the common DC power bus 120. The starter/generator 114 is electrically connected to rectifier 118 that converts AC power produced by the starter/generator 114 into DC power that is provided to the common DC power bus 120. The temporary storage 130 provides short term or transient power. In an embodiment of the invention, the temporary storage 130 comprises one or more electrolytic capacitors that are charged by the DC power on the common DC power bus 120 and deliver DC power to the bus during transient load conditions. The temporary storage 130 also provides power to the starter/generator 114 through the DC power bus 120 and rectifier 118 to power the starter/generator 114 during start-up of the engine 112. Alternatively, the temporary storage 130 may be provided by other known sources, such as flywheels, batteries, fuel cells, and the like.

The DC power of the common power bus 120 is delivered to a load through the DC-to-DC converter 124 and the inverter 126. The DC-to-DC converter 124 converts the DC power from the common power bus 120 into a different voltage DC output (e.g., 48 volts DC) used to supply a DC load 132. The inverter 126 converts the DC power from the common power bus 120 into an AC output, such as a reliable high voltage, three-phase AC output (e.g., 400/480 volts AC), used to supply an AC load 134. It should be understood that the AC output of the inverter 126 and the DC output of the converter 124 represent premium electric power that is substantially free of undesirable frequency variations, voltage transients, surges, dips or other disruptions.

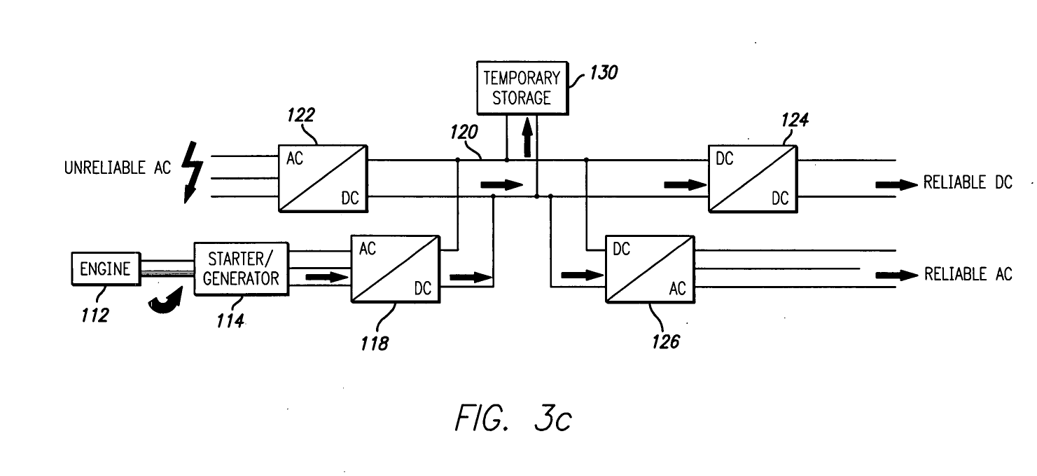

FIG. 3a illustrates normal operation of the distributed power generating system 100 with the AC mains supplying the common DC power bus 120 through rectifier 122. The temporary storage 130 is charged by the rectified DC power on the power bus 120. The DC power of the common power bus 120 is delivered to a load through the DC-to-DC converter 124 and inverter 126 as discussed above. The engine 112 and starter/generator 114 are not operating at this time.

FIG. 3b illustrates a condition of the distributed power generating system 100 in a first interval following failure of the AC mains. The temporary storage 130 provides DC power to the rectifier 118, which inverts the DC power to provide AC power to the starter/generator 114. In turn, the starter/generator 114 commences rotating the rotor shaft of the engine 112. The temporary storage 130 also supplies power to the common DC power bus 120 for delivery to a load through the DC-to-DC converter 124 and inverter 126 as discussed above. FIG. 3c illustrates a condition of the distributed generating system 100 in a second interval following failure of the AC mains. The engine 112 has started and reached an operational speed. The direction of current in the starter/generator 114 reverses, and the starter/generator now supplies power to the common DC power bus 120 for delivery to a load through the DC-to-DC converter 124 and inverter 126 and to recharge the temporary storage 130. This condition will continue until such time as the AC mains have recovered from the fault.

It should be appreciated that the distributed power generating system must strike a balance between the size/capacity of the temporary storage 130, the power drawn by the starter/generator 114, and the start-up time of the engine 112. It is desirable to limit the size of the temporary storage 130 to the minimum necessary to supply the load and the starter/generator 114 for the time needed to bring the engine 112 up to operational speed. If the engine 112 were brought up to speed too slowly, the temporary storage 130 would have to supply the load for a longer period of time and would hence require greater size and capacity. At the same time, if the power rating of the starter/generator 114 is not properly matched to the engine 112, the starter/generator would draw excessive power from the temporary storage 130 without appreciably decreasing the time for the engine 112 to be brought to operational speed.

In the present invention, an optimal balance between these parameters is met with the starter/generator 114 selected to have a short time torque capability higher than the rated torque of the engine 112 and starter/generator 114, so that the starter/generator 114 can bring the engine 112 quickly to full operation with respect to ignition, speed and torque. The fraction of the short time torque capability of the starter/generator 114 compared to the moment of inertia of the rotating part of the engine 112 can be optimized to achieve an acceleration time from zero to rated speed within less than a second, and more particularly within less than 0.2 second. In an exemplary embodiment of the invention, the starter/generator 114 has a short time torque capability at least two times higher than the rated torque of the engine 112 and starter/generator 114. In yet another exemplary embodiment of the invention, the starter/generator 114 has a short time torque capability at least four times higher than the rated torque of the engine 112 and starter/generator 114. Due to a typically lower short time torque capability (roughly 1/10 of the rated torque of the engine 112 and starter/generator 114) and higher moment of inertia, conventional systems result in substantially longer start-up times.

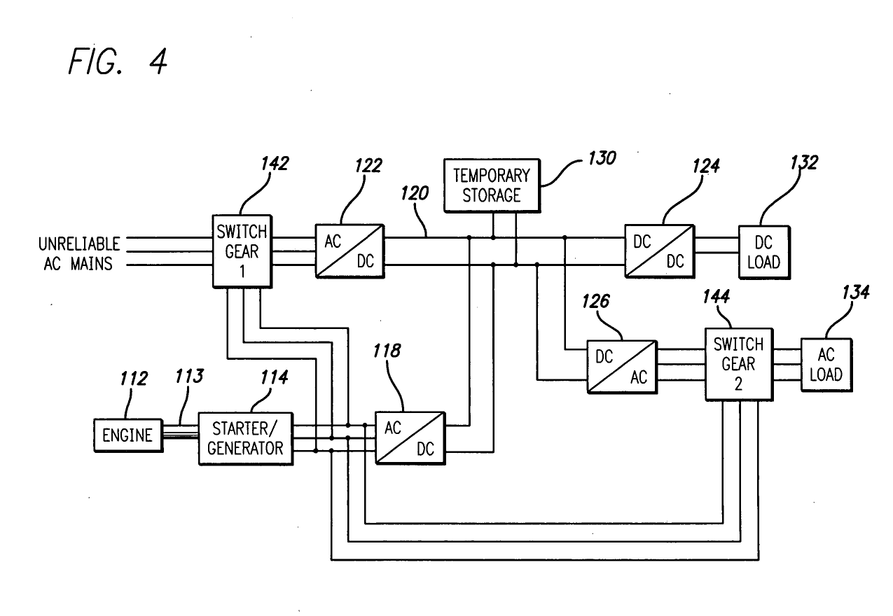

FIG. 4 illustrates an alternative embodiment of a power generating system 100 that provides some additional flexibility and redundancy. The power generating system 100 is substantially identical to the embodiment of FIG. 2, with the addition of switchgear 142 and switchgear 144. Switchgear 142 is connected between the AC mains and the rectifier 122, and is further coupled to the AC interface defined between the starter/generator 114 and the rectifier 118. The switchgear 142 is adapted to connect the AC mains to the rectifier 122 and/or to the starter/generator 114. Switchgear 144 is connected between the inverter 126 and the AC load 134, and is further coupled to the AC interface defined between the starter/generator 114 and the rectifier 118. The switchgear 144 is adapted to connect either the inverter 126 or the starter/generator 114 to the AC load 134, and/or the inverter 126 to the starter/generator 114.

The inclusion of the switchgear 142, 144 enables a number of alternative operating modes and system redundancies. Power from the AC mains can be supplied through the switchgear 142 to either the DC power bus 120 through rectifier 122 and/or to the starter/generator 114. This way, the starter/generator 114 can be started using power supplied by the AC mains rather than through the rectifier 118 (as discussed above), such as for purposes of testing the distributed power system. After the engine 112 has started and the starter/generator 114 begins producing AC power, the AC power can be delivered to the DC power bus 120 through first switchgear 142 and rectifier 122, instead of passing through rectifier 118. This provides an alternative path for delivery of back-up power to the DC power bus 120, which may be advantages in case of a failure of the rectifier 118.

Further, when the AC mains are supplying the common DC power bus 120 through rectifier 122, the DC power of the common power bus 120 is inverted to AC by inverter 126 and delivered to the AC load 134 through the switchgear 144. Upon detection of a failure of the AC mains, the starter/generator 114 can be supplied with AC power to start the engine 112 either through the rectifier 118 (as discussed above) or through the switchgear 144. This way, the inverter 126 provides redundancy for the rectifier 118. Moreover, the rectifier 118 would not have to be adapted to operate as an inverter. After the engine 112 has started and the starter/generator 114 begins producing AC power, the AC power can be delivered directly to the AC load 134 through the switchgear 144, thereby avoiding the need to rectify and invert the AC power through the rectifier 118 and inverter 126, respectively.

Having thus described a preferred embodiment of a distributed power generating system, it should be apparent to those skilled in the art that certain advantages of the system have been achieved. It should also be appreciated that various modifications, adaptations, and alternative embodiments thereof may be made within the scope and spirit of the present invention. The invention is further defined by the following claims.

What is claimed is:

1. A power generating system, comprising:
a power bus electrically coupled to commercial power and to a load;
an internal combustion engine;
a starter/generator operatively coupled to the engine and electrically coupled to the power bus, the starter/generator having a short time torque capability higher than the rated torque of the engine and the starter/generator;
a temporary storage device electrically coupled to the power bus, wherein, upon a failure of the commercial power, the starter/generator starts the engine from a standstill condition and rapidly brings the engine to an operational speed sustainable by the engine alone, the temporary storage device supplying electrical power to the power bus for delivery to the load and for powering the starter/generator until the engine reaches the operational speed, whereupon the starter/generator takes over supply of electrical power to the power bus for delivery to the load; and
first switchgear electrically coupled to the power bus, the starter/generator and the load, the first switchgear selectively enabling at least one of delivery of electrical power to the load from the starter/generator without passing through the power bus, delivery of electrical power from the temporary storage device to the starter/generator through the power bus, and delivery of electrical power from the power bus to the load.

2. The power generating system of claim 1, further comprising second switchgear electrically coupled to the commercial power, the starter/generator and the power bus, the second switchgear selectively enabling at least one of delivery of electrical power to the starter/generator from the commercial power without passing through the power bus, delivery of electrical power from the commercial power to the power bus, and delivery of electrical power from the starter/generator to the power bus.

3. The power generating system of claim 1, further comprising a rectifier electrically coupled between the commercial power and the power bus, the rectifier converting the commercial power to DC electrical power for communication on the power bus.

4. The power generating system of claim 3, wherein the load further comprises a DC load, and further comprising a DC/DC converter electrically coupled between the power bus and the DC load.

5. The power generating system of claim 1, further comprising a rectifier electrically coupled between the starter/generator and the power bus, the rectifier converting the electrical power generated by the starter/generator to DC electrical power for communication on the power bus.

6. The power generating system of claim 1, wherein the load further comprises an AC load, and further comprising an inverter electrically coupled between the power bus and the first switchgear.

7. The power generating system of claim 1, wherein the starter/generator has a short time torque capability higher than a rated torque of said engine.

8. The power generating system of claim 1, wherein said engine reaches the operational speed in less than one second.

9. The power generating system of claim 1, wherein said engine reaches the operational speed in less than 0.2 second.

10. The power generating system of claim 1, wherein the temporary storage device further comprises at least one capacitor charged by electrical power on the power bus.

11. The power generating system of claim 1, wherein said engine further comprises a reciprocating internal combustion engine.

12. A power generating system, comprising:
a power bus electrically coupled to commercial power and to a load;
an internal combustion engine;
a starter/generator operatively coupled to the engine and electrically coupled to the power bus, the starter/generator having a short time torque capability higher than the rated torque of the engine and the starter/generator;
a temporary storage device electrically coupled to the power bus, wherein, upon a failure of the commercial power, the starter/generator starts the engine from a standstill condition and rapidly brings the engine to an operational speed sustainable by the engine alone, the temporary storage device supplying electrical power to the power bus for delivery to the load and for powering the starter/generator until the engine reaches the operational speed, whereupon the starter/generator takes over supply of electrical power to the power bus for delivery to the load; and
first switchgear electrically coupled to the commercial power, the starter/generator and the power bus, the first switchgear selectively enabling at least one of delivery of electrical power to the starter/generator from the commercial power without passing through the power bus, delivery of electrical power from the commercial power to the power bus, and delivery of electrical power from the starter/generator to the power bus.

13. The power generating system of claim 12, further comprising second switchgear electrically coupled to the power bus, the starter/generator and the load, the second switchgear selectively enabling at least one of delivery of electrical power to the load from the starter/generator without passing through the power bus, delivery of electrical power from the temporary storage device to the starter/generator through the power bus, and delivery of electrical power from the power bus to the load.

14. The power generating system of claim 12, further comprising a rectifier electrically coupled between the commercial power and the power bus, the rectifier converting the commercial power to DC electrical power for communication on the power bus.

15. The power generating system of claim 14, wherein the load further comprises a DC load, and further comprising a DC/DC converter electrically coupled between the power bus and the DC load.

16. The power generating system of claim 12, further comprising a rectifier electrically coupled between the starter/generator and the power bus, the rectifier converting the electrical power generated by the starter/generator to DC electrical power for communication on the power bus.

17. The power generating system of claim 13, wherein the load further comprises an AC load, and further comprising an inverter electrically coupled between the power bus and the second switchgear.

18. The power generating system of claim 1, wherein the starter/generator has a short time torque capability higher than a rated torque of said engine.

19. The power generating system of claim 1, wherein said engine reaches the operational speed in less than one second.

20. The power generating system of claim 1, wherein said engine reaches the operational speed in less than 0.2 second.

21. The power generating system of claim 1, wherein the temporary storage device further comprises at least one capacitor charged by electrical power on the power bus.

22. The power generating system of claim 1, wherein said engine further comprises a reciprocating internal combustion engine.
